(19) United States
(12) Patent Application Publication
(10) Pub. No.: US 2015/0334060 A1
(43) Pub. Date: Nov. 19, 2015

(54) Method and Computer Network for Transmitting Real-Time Communications

(71) Applicant: FTS COMPUTERTECHNIK GMBH, Wien (AT)

(72) Inventors: Wilfried Steiner, Wien (AT); Gunther Bauer, Wien (AT); Stefan Rebernig, Wien (AT)

(21) Appl. No.: 14/443,013

(22) PCT Filed: Nov. 18, 2013
(86) PCT No.: PCT/AT2013/050224

§ 371 Date: May 14, 2015

(30) Foreign Application Priority Data
Nov. 16, 2012 (AT) A50522/2012

(51) Int. Cl. H04L 12/58; H04L 12/815

(52) U.S. Cl. CPC H04L 51/04; H04L 47/22

(57) ABSTRACT

The disclosed embodiments of the invention provide a method for the transmission of messages in a computer network comprised of computing nodes which are interconnected via active components. The computing nodes exchange real-time-messages that are allocated defined CM time intervals of constant duration. The bandwidth available for real-time messages within a CM time interval is limited to a defined real-time bandwidth.

The computing nodes periodically transmit time-triggered messages. The period duration of the time-triggered messages is a function of the time duration of the CM time intervals, and the transmission timing of time-triggered messages transmitted from different computing nodes to the same active component is phase-shifted, so that time-triggered messages from different computing nodes can be received in the active component at different times. The total number of the bandwidths within one CM time interval occupied by time-triggered messages and real-time messages does not exceed the value of the real-time bandwidth.

The invention pertains to a method for the transmission of messages within a computer network, wherein the computer network is comprised of a number of computing nodes being interconnected via one or multiple active components, whereby each computing node is connected to an active component via a communication line, and wherein the computing nodes are exchanging at least some of the messages in the form of real-time messages, whereby defined Class Measurement Time Intervals of a constant time duration are allocated to the real-time messages, and wherein the bandwidth available for the real-time messages within one CM time interval is limited to a defined real-time bandwidth.

The invention furthermore pertains to a computer network for the execution of one above-named method for the transmission of messages, wherein the computer network is comprised of a number of computing nodes, which are interconnected via one or multiple active components, whereby each computing node is connected to an active component via a communication line, and wherein the computing nodes are exchanging at least some of the messages in the form of real-time messages, whereby defined Class Measurement Time Intervals of a constant time duration are allocated to the real-time messages, and wherein the bandwidth available for the real-time messages within one CM time interval is limited to a defined real-time bandwidth.

In computer technology, various standards for the networking of single computers into a computer network have been established. These standards follow the requirements of the applications operating in the computer network. A special class of applications are real-time systems, in which the duration of the transmission of messages in the network is a central characteristic. As a sample of a standard for computer networks suitable as real-time systems, standard SAE AS6802 shall be mentioned at this point. Samples of real-time systems are: Control systems on board an aircraft, control systems in industrial manufacturing facilities, and industrial robots.

One cost-efficient method to minimize the transmission time, the latency, of messages in a computer network is the implementation of time-controlled message transmission, i.e. time-triggered communication. In time-triggered message transmission, all computers or a group of computers, which are connected by way of a network to create a computer network, are synchronized such that the synchronized computers implement local clocks, which at every point in time in real-time differ from each other by a calculable time value error only. Accordingly, synchronized computers have a common view of the time, whereby the view is subject to a calculable, most often small error, e.g. in the microsecond range.

In addition, in time-triggered communication, a communication plan, a so-called “schedule” is developed. This schedule describes at which points in time within the synchronized time the computer feeds which message into the network. This allows to make sure that the times at which a computer feeds messages into the computer network, are sufficiently spaced from points in time at which another computer feeds messages into the computer network, so that the messages of one computer and those of another computer never occupy resources of the network at the same time. The network itself may contain active components like, for example, bridges or switches. In this case, the schedule may also contain points in time at which messages shall be forwarded. The SAR AS6802 standard describes, how time-triggered message transmission can be implemented into an Ethernet (IEEE 802.3)-based network.

Driven by the continuously increasing importance of real-time systems, the industry is now attempting to make existing IT network standards real-time-capable. In particular, the IEEE 802.1Q standard, starting at version IEEE 802.1Q-2011, has been supplemented with features, which ensure real-time response for a limited number of messages. These features are commonly grouped under the term “Audio-Video Bridging” (AVB).

In IEEE 802.1Q-p2011, real-time response is achieved with the following functions and configurations:

(a) Real-time messages are assigned high—or even the highest—priority in the network,
(b) Real-time messages are transmitted with a predefined non-synchronized period, and
(c) The bandwidth available for real-time messages is limited and defined.

From points (a)-(c) follows that the latency of real-time messages can be calculated, and that with appropriate selection of the parameters (priority, period and bandwidth) a sufficiently satisfactory real-time response can be achieved. For the sake of completeness, it shall be mentioned here that IEEE 802.1Q-2011 does not implement time-triggered message transmission, however, the capability of time-triggering in IEEE 802.1Q is being developed in the current IEEE 802.1Qbv standardization project.

As a sample for a configuration according to IEEE 802.1Q-2011 shall be cited the so-called Service Class A “SR Class A”. For SR Class A, IEEE 802.1Q-2011 defines the following default configurations: (a) Priority is set to 3, (b) the Class Measurement Interval (CMI)—forthwith generally also referred to as CM time interval —is set to 125 microseconds, and (c) the maximum bandwidth for SR Class A is set to 75%. In such a setup, according to calculations of the IEEE 802.1 Working Group, a guaranteed latency of 2 milliseconds is achieved in a network, whereby in the network a maximum of six bridges (also called switches or star couplers) are allowed between the transmitter and the receiver of a real-time message.

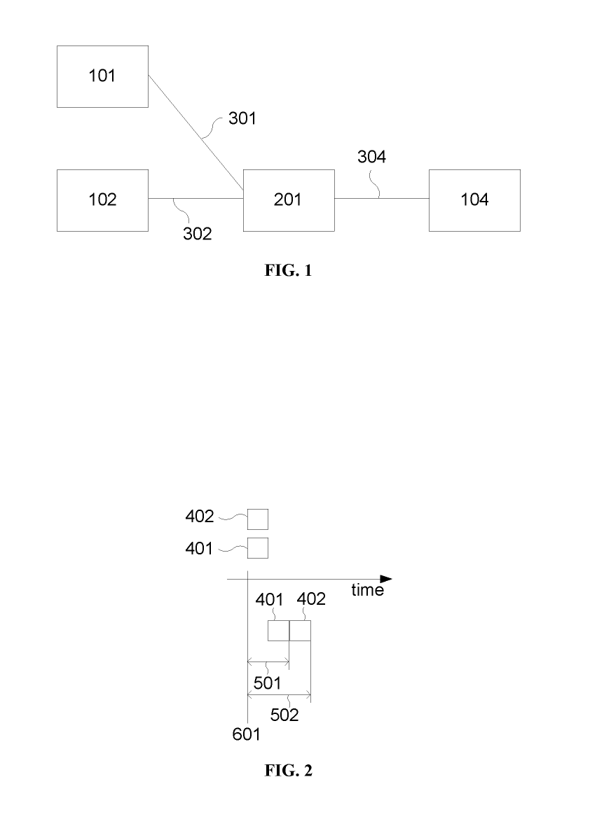

Accordingly, a computer implementing the AVB protocol is allowed to transmit a message with a specific ID every 125 microseconds (for SR Class A). If for example, as in FIG. 1, which represents the known state of the art, two computers 101, 102 transmit messages to a bridge 201 according to the AVB protocol, both computers 101, 102 operate for themselves but not jointly. The computers 101, 102 can therefore transmit messages, which arrive at the same times at the bridge 201. In the worst case, if both computers transmit messages periodically, this applies to all messages of 101, 102.

The CM time interval defines the calculation period of the bandwidth parameter. In AVB, bandwidth for streams is reserved in the bridges dynamically. This means that if, for example, a talker at its bridge announces a stream S1 with the content that it transmits for S1 every 125 microseconds a number xx of messages with a length of nn bytes, the resulting bandwidth bbb is

(nn+42)*8*xx/125 μs=bbb bps

(42 bytes are overhead for header, . . . ). The CMI (in this sample 125 μs) accordingly defines the interval for the calculation of the bandwidth required for a stream.

However, a direct conclusion from this setup is, that a maximum of thirteen Ethernet messages (in Ethernet also called “frames”) with a minimum length of the SR Class A can be used for each port, since otherwise the 75% limit for the maximum bandwidth would be exceeded. (A minimum Ethernet frame has a length of 6.72 μs at 84 bytes; at 75% bandwidth at a CMI of 125 μs, the result is an available time of 93.75 μs. 93.75 μs/6.72 μs results in a maximum of 13 minimum Ethernet frames at a bandwidth of 100 Mbps).

It is an objective of the invention to specify a method, with which in a distributed computer network which, for example, implements the IEEE 802.1Q-2011 (or a future IEEE 802.1Q standard) or is based on similar specifications as specified in this standard, the number of transmitted real-time messages within the applicable time unit can be increased. In particular, it is a task of the invention to achieve the above objective, without increasing the latency of non-time-triggered real-time messages, like AVB messages.

This task is solved using a method named at the beginning in such fashion that, according to the invention, time-triggered messages are further transmitted by computing nodes, whereby according to a defined schedule the time-triggered messages are transmitted periodically by the computing nodes, wherein the duration of the period of the time-triggered messages is a function of the time period of the CM time intervals, wherein the transmission times of the time-triggered messages being transmitted by different computing nodes to the same active components are out of phase in relation to each other,

such that the time-triggered messages from different computing nodes are received at different times, i.e. at non-overlapping time intervals, by the active component, and wherein the total number of bandwidths occupied by time-triggered messages and real-time messages within a CM time interval does not exceed the size of the real-time bandwidth.

This objective is furthermore achieved with a computer network mentioned at the beginning, such that, according to the invention, at least two computing nodes are provided, which are configured to transmitted time-triggered messages, wherein according to a defined schedule the time-triggered messages of the at least two computing nodes are transmitted periodically, wherein the period durations of the time-triggered messages are a function of the time duration of CM time intervals, wherein the timing of the transmission of time-triggered messages being transmitted from different computing nodes to the same active components is phase-shifted such that the time-triggered messages from different computing nodes are received by the active component at different times, i.e. at non-overlapping time intervals, and wherein the total number of bandwidths occupied by time-triggered messages and real-time messages within one CM time interval does not exceed the real-time bandwidth.

The principally available maximum transmission rate for communication via the communication lines is called the “port transmit rate”. For example, the “port transmit rate” in Ethernet is 10 Mbps, 100 Mbps, 1 Gbps or higher.

The real-time bandwidth specifies the space (e.g. in %) of this “port transmit rate”, which is available for real-time messages.

The invention at hand provides that the total number of bandwidths of the time-triggered messages and the non-time-triggered real-time messages is smaller or equal to the specified real-time bandwidth originally provided for the non-time-triggered real-time messages. Thus, the time-triggered messages and the non-time-triggered real-time messages share the percentage of the “port transmit rate” otherwise available for non-time-triggered real-time messages.

The invention at hand therefore differentiates between “ordinary” real-time messages, e.g. AVB messages, which are communicated without time-trigger, and newly introduced time-triggered messages or time-triggered real-time messages.

The method being introduced allows the allocation of a scalable, higher number of real-time messages to a port of an active component, e.g. the port of a bridge.

This is achieved by implementing time-triggered communication for a part of the messages being transmitted within the computer network, whereby special specifications provided for time-trigger schedule as well as the bandwidth specifications provided for the non-time-triggered real-time messages, e.g. for AVB messages must be observed. Therefore, the time-triggered messages appear like AVB messages. As a result, the invention can be used to expand and reconfigure a standard Ethernet computer network in order to make better use of the bandwidth.

The invention at hand is able to improve the timing performance, e.g. in an IEEE.IQ-2011-based network. Introduced specifically is a method being used for the synchronized transmission of messages, so that the bandwidth, which e.g. according to the IEEE 802.1Q-211 standard, is allocated to exactly one network participant, and using this method, can be coordinated or shared by multiple network participants. The method allows a guarantee of latency characteristics for a higher number of messages than is possible in a network based on IEEE 802.1Q-2011 only.

The invention at hand therefore discloses an innovative method describing how in a distributed computer network, which e.g. implements the IEEE 802.1Q-2011 (or a future IEEE 802.1Q standard), the number of real-time messages can be increased. The method provides the implementation of time-triggered communication and that a part of the real-time messages described in the IEEE 802.1Q-2011, for example a part of the SR Class A messages, is being communicated in a time-triggered manner. In addition, the method discloses how the schedules of the time-triggered messages must look to make sure that the latency characteristics of those real-time messages that are not transmitted in a time-triggered manner

will not be negatively affected by the time trigger. According to the invention, the time trigger is thereby implemented into the end systems, i.e. into the computers and not into the bridge.

It is advantageous if the time-triggered messages of at least two of the computing nodes are transmitted.

Also proven advantageous for an optimal sequence of the communication has been a period duration of the time-triggered messages, which is an integral multiple of a CM time interval.

It may also be provided that the period duration of the time-triggered messages is equal to the duration of a CM time interval divided by an integer number.

In one embodiment of the invention it is provided that all time-triggered messages are transmitted with the same period duration.

In another embodiment of the invention it is provided that time-triggered messages that are controlled by at least two node computers are transmitted with differing period durations.

It is useful for the transmission times of time-triggered messages with the same period duration to be selected such that the transmission times of time-triggered messages are chosen such that the transmission times of two consecutive time-triggered messages from different node computers are spaced exactly or at least one time interval apart, wherein this time interval is equal to the period duration divided by the number of node computers.

In the case of two node computers, for example, which are transmitting time-triggered messages, two consecutive messages from different node computers are time-shifted by half the period duration. If the period duration is twice as long as the CM time interval then the two messages (i.e. their transmission times) are spaced apart by exactly one CM time interval.

It is advantageous for a schedule providing the transmission of two or more time-triggered messages of different note computers within one CM time interval to furthermore provide that the transmission time of the nth time-triggered message occurs at the earliest after the transmission time of the (n−1)th message plus the transmit duration of the (n−1)th message, whereby n=2, 3, 4 . . . .

It may furthermore be provided that two or more differing classes of real-time messages are transmitted within the network, whereby such differing classes differ at a minimum in the CM time interval allocated to the messages of the respective class.

The invention may provide that real-time messages of a specific class, which are transmitted as time-triggered messages, are transmitted with a period duration which is a function of the CM time interval of these real-time messages.

Often or as a rule, messages of different classes also differ in their priorities. However, it may also be provided that the time-triggered messages are assigned the same or a higher priority than the corresponding real-time messages (i.e. when a real-time messages is transmitted as a time-triggered message, the time-triggered real-time message is assigned the same or a higher priority than it would have had as a non-time-triggered message).

In concrete, the invention provides that at least a portion of the real-time messages are transmitted as time-triggered messages. This means in particular that of those real-time messages which usually are not transmitted as time-triggered messages at least a portion is transmitted as time-triggered (real time) messages. Other messages communicated inside the network, which are not real-time messages, i.e. in particular standard Ethernet messages, are usually not communicated as time-triggered messages and neither within the scope of this invention.

Furthermore may be provided that at least a portion of the real-time messages of a specific class are transmitted as time-triggered messages.

If, for example, real-time messages of the AVB class “SR Class A” are transmitted as time-triggered messages, the duration of the CM time interval CMI is 125 microseconds; AVB messages of the class “SR Class A”, which are transmitted as time-triggered messages (“TT-SR Class A messages”, i.e. time-triggered SR Class A messages”) are transmitted accordingly with a period duration which is a function of this value, e.g. an integral multiple, i.e. for example 1 time, 2 times, 3 times, etc. 125 microseconds, or 125 microseconds divided by an integer number.

If, for example, (in addition or alternatively) messages of the AVB class “SR Class N” are transmitted as time-triggered messages (“TT SR Class B messages”), then the period duration is calculated based on the corresponding CMI time interval for SR Class B messages, which is 250 microseconds.

The transmission of the messages can be scheduled in an especially easy way when it is provided that time-triggered messages are transmitted at the beginning of a CM time interval.

Finally, it is advantageously provided as well that the bandwidth available for real-time messages can be arbitrarily allocated between time-triggered and non-time-triggered real-time messages.

As already mentioned above, it may be advantageously provided for the time-triggered messages to exhibit at least the priority of the (non-time-triggered) real-time messages or a higher priority.

For example, AVB messages of SR Class A/SR Class B, which are also transmitted as time-triggered messages, have the same or a higher priority than the SR Class A/SR Class B messages; however, it may also be provided that all time-triggered messages are assigned a higher priority than the non-time-triggered (AVB) real-time messages.

Finally, it is advantageously provided that time-triggered messages transmitted by the same computing node contain the same identifying characteristics, e.g. the same StreamID.

The length of a typical CM interval is 125 microseconds and/or 250 microseconds.

In addition, it is usually provided that the defined real-time bandwidth is limited to a maximum of 75% of the bandwidth available for real-time messages within a CM time interval.

In the following, the invention is explained in greater detail based on a sample embodiment. It shows

FIG. 1 a computer network comprised of three computing nodes, e.g. computers and a bridge, wherein the bridge implements the IEEE 802.1Q standard,

FIG. 2 a data flowchart, in which two messages are received by a bridge at about the same time, and wherein the bridge stores the messages and forwards them in consecutive order,

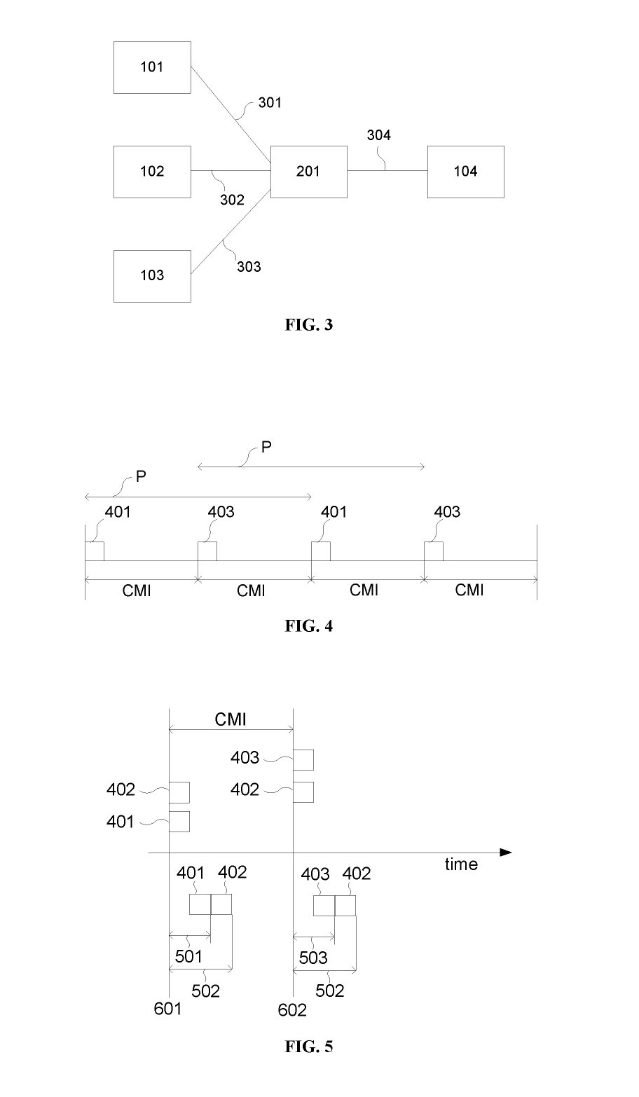

FIG. 3 a computer network comprised of four computing nodes and one bridge, with the bridge implementing the IEEE 802.1Q standard, and wherein two of the three computing nodes implement time-triggered communication,

FIG. 4 a schedule for time-triggered messages in which the time-triggered messages are scheduled by two computing nodes in such fashion as to be transmitted with a period which is equal to twice the duration of the Class Measurement Interval (CMI),

FIG. 5 a data flowchart in which one time-triggered message and one non-time-triggered message each are received at about the same time by a bridge,

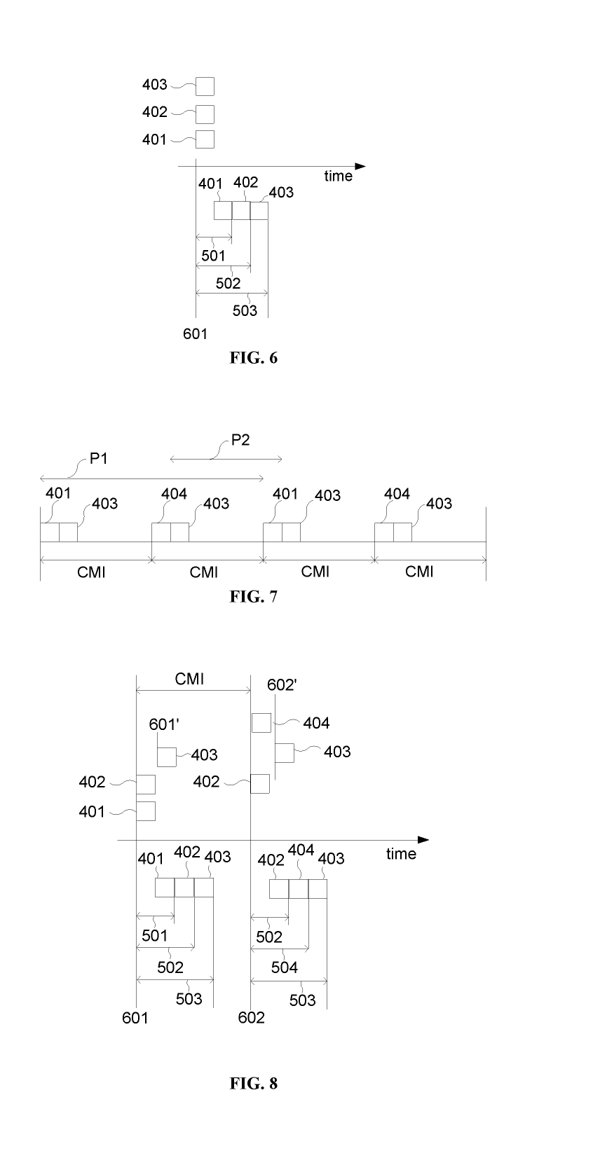

FIG. 6 a data flowchart, in which three different messages are transmitted as non-time-triggered messages,

FIG. 7 a schedule for time-triggered messages, wherein time-triggered messages are transmitted from two computing nodes with different periods,

FIG. 8 a data flowchart, in which three time-triggered messages and one non-time-triggered message are communicated,

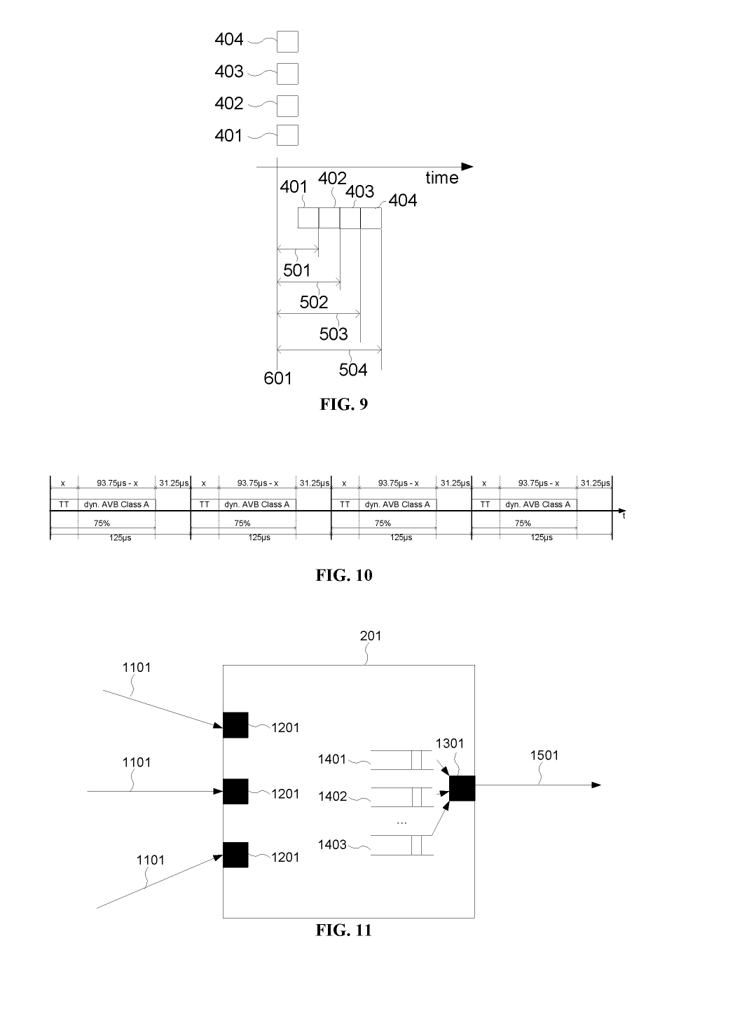

FIG. 9 a data flowchart, in which four different messages are transmitted as non-time-triggered messages,

FIG. 10 a schematic representation of the bandwidth allocation between time-triggered and non-time-triggered real-time messages, and

FIG. 11 a schematic view of the internal operations of a bridge.

The following concrete sample explains one of the many possible embodiments of the new method.

FIG. 1 represents a sample computer network known from the prior state of the art, which is comprised of three computing nodes 101, 102, 104 which exchange messages with each other via an active component in the form of a bridge 201. For this purpose, computing nodes 101, 102, 104 are connected via communication lines, preferably to bi-directional communication lines 301, 302, 304, as shown, to the bridge 201. The bridge 201 implements the IEEE 802.1Q-2011 standard, i.e. this bridge corresponds to or operates according to the said standard. All messages being exchanged are Ethernet messages.

One active component has “Knowledge of the Network” and storing methods. It knows where a message must be forwarded to. A passive component would be, for example, a hub which neither stores messages nor addresses them correctly—such a hub will only “broadcast” incoming messages. Such active component is typically a so-called “bridge” or a switch or, for example, a router with the corresponding functionality.

FIG. 2 represents a communication method for the computer network from FIG. 1. It is based on the assumption that the computer network does not implement any time-triggered communication. In this case, it is possible that one computing node 101 and one additional computing node 102 transmit messages 401, 402 at about the same time, whereby both messages 401, 402 are addressed to a third computing node 104. Since this third computing node 104 is connected to the bridge 201 via one communication line 304 only, the messages 401, 402 must be transmitted by the bridge 201 consecutively to the computing node 104. In the sample from FIG. 2, message 401 is transmitted first and only then is message 402 transmitted. As a result, message 401 has a latency 501 and message 402 has a latency 502, wherein the latency (measured in time units) is measured beginning at the time 601 of the start of the receipt of a message in the bridge 201 until the complete forwarding of the message by the bridge 201. Standard IEEE 802.1Q ensures that for real-time messages, the number of the messages allowed to overlap during receipt in the bridge 201 is limited; the transmission latency of real-time messages can therefore be determined already in an IEEE 802.1Q-2011 computer network. The disadvantage of this solution, however, is the limited number of real-time messages able to be transmitted.

FIG. 3 shows a network enhanced in accordance with the invention. It consists of four computing nodes 101, 102, 103, 104 connected via communication lines 301, 302, 303, 304 to the bridge 201. In this computer network, the two computing nodes 101, 103 implement a time-triggered communication, i.e. they transmit time-triggered messages.

FIG. 4 illustrates a schedule for the computing nodes 101, 103 of the computer network shown in FIG. 3. The time axis is pursuant to FIG. 4 divided into time periods, wherein each time period exhibits a length corresponding to the length of the CM time interval CMI, in the following also called Class Measurement Interval CMI, representing in the selected sample four intervals with a time duration of 125 μs each. The schedule now describes that the computing nodes periodically transmit messages with a period P, which in this case is twice the length of the Class Measurement Interval CMI. The term Class Measurement Interval CMI is hereby defined in the IEEE 802.1Q-2011 standard; for example in the case of SR Class A, the CMI is set to 125 microseconds. The schedule furthermore provides for the computing nodes 101, 103 to respectively transmit their messages 401, 403 at a time delay, i.e. with a phase shift having the length of one CMI Class Measurement Interval.

Essentially, the time-triggered, periodic messages 401, 403 within a CM time interval can be transmitted at any point of such time interval (wherein different messages 401 of a node 101 and different messages 403 of a node 103 always occur at the same point within different CMI time windows), preferably, the messages 401, 403 are transmitted, as shown, at the beginning of a CMI. This represents an especially straightforward and reliable implementation of the invention.

The non-time-triggered real-time messages 402, e.g. AVB messages, which are not shown in the schedule in FIG. 4, are transmitted asynchronously “around the time-triggered message in a CM interval”. Important in this respect is the bandwidth limitation since according to the invention, the total number of bandwidths for the time-triggered messages and the non-time-triggered messages is not allowed to exceed the maximum available defined real-time bandwidth for real-time messages.

For non-time-triggered real-time messages of the SR Class A type, for example, 75% of the available bandwidth are available, i.e. in a CM time interval CMI essentially only 75% of the available bandwidth and/or the available time—for SR Class A messages, this would mean 75% of 125 microseconds—are allowed to be used. If, according to the invention, time-triggered (real-time) messages are introduced in addition, then the non-time-triggered and the time-triggered messages share these 75% of the available bandwidth, wherein the ratio of how this limited bandwidth is being divided up between time-triggered and non-time-triggered messages is essentially arbitrary.

The “remaining” time period within a CMI CM time interval after, for example, the message 401 was transmitted, can be filled up to 75% with AVB messages, i.e. with real-time messages; the remaining 25% are, for example, standard Ethernet messages (best-effort traffic). A schematic overview of this aspect is shown in FIG. 10.

FIG. 5 illustrates the communication behavior of the computer network represented in FIG. 3 and configured according to the schedule in FIG. 4. Here, the left part of the data flowchart is an exact match of the data flowchart from FIG. 2. Since computing node 102 does not communicate in a time-triggered manner, one possible scenario would be—as shown on the left side of FIG. 5—that one message 402 of computing node 102 arrives at about the same time 601 with a message 401 of the time-triggered communicating computing node 101 at the active component in the form of a bridge 201. Message 401, for example, would be message 401 shown at the very left in FIG. 4.

The bridge 201 accordingly transmits messages 401, 402 consecutively via the communication channel (communication line) 304 to computing node 104.

Message 401 exhibits a latency 501, and message 402 a latency 502.

In this case, the bridge 201 can either randomly select in what sequence the two messages 401, 402 will be transmitted, or the bridge 201 has its own schedule, which defines in what sequence approximately at the same time arriving messages shall be transmitted.

FIG. 5 further shows on its right side a time 602, which is a time period CMI later than the time 601. Here is, where the advantage of the invention and the inventive method in comparison to the IEEE 802.1Q-2011 standard only is recognizable. In this right part, the bridge 201 receives at about the same time 602 messages 402 (non-time-triggered) and 403 (time-triggered) from the two computing nodes 102, 103. There is, however, no possibility that also a message 401 of the computing node 101 is received at about the same time due to the fact that the schedule of the time-triggered communication provides a message 401 of the computing node 101 again only in the next CMI, as shown in FIG. 4. Due to the fact that therefore only message 401 or message 403 but not both messages 401, 403 at the same time may collide with message 402, the additional message 403 does not result in an additional latency in relation to the communication scenario in FIG. 2, shown for the message 402 because, as can be obtained from the right part of FIG. 5, message 403 exhibits a latency 503, and message 402 a latency 502 (under the assumption that message 401 and message 403 have the same length). FIG. 5 therefore shows by way of example that, according to the invention, e.g. for three messages 401, 402, 403 in place of only two messages according to FIG. 2 the latency of the non-time-triggered message 402 is not being impaired. Accordingly, FIG. 5 shows how time-triggered communication allows the transmission of more real-time messages without affecting the existing latency characteristics of real-time messages.

The active component in the form of a bridge stores the messages and forwards them consecutively. According to the invention it is, due to the scheduling of the time-triggered messages, impossible for time-triggered messages to be received by the bridge in about the same or overlapping time windows. The invention additionally results in that for the situation shown by way of example in FIG. 5 the non-time-triggered messages each can be delayed by one time-triggered message only; a delay of a non-time-triggered message due to two or multiple time-triggered messages is due to the invention in the situation shown in FIG. 5 not possible.

Generally can be concluded that the non-time-triggered messages are delayed by a maximum number of time-triggered messages only, with this maximum number resulting from the schedule. For example, if a number N of time-triggered messages are scheduled immediately one after the other, it would mean that the bridge would receive these N time-triggered real-time messages immediately one after the other. If the schedule provides that afterwards no time-triggered messages are scheduled for a sufficient length of time, then the non-time-triggered messages can be processed. The delay of the non-time-triggered real-time messages due to the time-triggered messages can therefore be calculated based on the schedule of the time-triggered real-time messages.

The term “at the same time” or “at about the same times” shall be understood to mean that two messages are received “at the same time” or “at about the same times” if the times of their forwarding by the bridge may affect one another, i.e. if the forwarding of one message may be delayed by the other message. This is called the “concurrent”, “about concurrent” or “at about concurrent” transmission of messages to a bridge (active component).

For a better understanding of the invention, FIG. 6 shows a data flowchart, in which three different messages 401, 402, 403 are transmitted as well. However, in contrast to the representation in FIG. 5, all three messages 401, 402, 403 in FIG. 6 are non-time-triggered.

As FIG. 6 shows, it is therefore possible for all three messages 401, 402, 403 to be received by the bridge at about the same times or overlapping time windows 601. As shown in FIG. 6, in the worst case a message 403 will be delayed by two messages 401, 402 by the time duration of the “length” of the two messages 401, 402.

FIG. 6 shows here only an exemplary scenario. Since the messages are non-time-triggered and not provided with priorities, the sequence of the transmission of the messages by the bridge is non-deterministic. Regarding the latency, it must therefore be assumed for the worst case that any one of the three messages 401, 402, 403 may be delayed by two messages.

FIG. 7 shows another schedule for time-triggered messages 401, 403 according to the invention, in which the time-triggered messages 401, 403 are scheduled by to computing nodes such that the messages 403 of a computing node are transmitted with the period P2 of the CM time interval (Class Measurement Interval) CMI, and the messages 401 of the other computing node with a period P1, which corresponds to twice the time duration of the Class Measurement Interval CMI.

The schedule further provides that the times for the different time-triggered messages 401, 403 are scheduled such that upon occurrence of the different time-triggered messages 401, 403 within a Class Measurement Interval CMI these time-triggered messages 401, 403 will not coincide, i.e. that they won't occur at the same time. For this purpose it is provided, for example, that the period for the time-triggered message 403 begins exactly or at the earliest after the duration of a time-triggered message 401 has expired.

Preferably provided furthermore is that both messages 401, 403 occur consecutively at the beginning of the Class Measurement Interval CMI.

FIG. 8 shows a data flowchart, in which a schedule from FIG. 7 has been implemented. According to FIG. 8, three time-triggered messages 401, 403, 404 and one non-time-triggered message 402 are communicated. The time-triggered message 403 has a period equal to the Class Measurement Interval CMI, the second and the third time-triggered message 401, 404 each have a period equaling the double of one CMI. Message 401 and message 404 are also transmitted with an offset of half of a period length, i.e. by the length of the Class Measurement Interval CMI.

For the non-time-triggered message 402 it is assumed that it is transmitted with the period of the Class Measurement Interval CMI. As shown on the left side of FIG. 8 receives the bridge at about the same time 601 the non-time-triggered message 402 and the time-triggered message 401, followed by the time-triggered message 403 at a time 601′, as provided by the schedule in FIG. 7. These three messages are forwarded by the bridge with the latencies 501, 502, 503 for the messages 401, 402, 403. The shown sequence of the messages serves as a sample only, however, it clearly indicates that the maximum latency of a message 401, 402, 403—in the shown sample for message 403—is two message lengths.

The right side of FIG. 8 shows that at a later time 602 which is—delayed by the length of the Class Measurement Interval CMI—after the time 601, the non-time-triggered message 402 and the time-triggered message 404 are received by the bridge at about the same time, followed by (at the time 602′) the time-triggered message 403 as provided by the schedule in FIG. 7. Here, the maximum latency of messages 402, 403, 404—in the shown case, for message 403—is again two message lengths.

FIG. 9 shows for comparison a data flowchart in which four messages 401, 402, 402, 404 are communicated as well, however, all four messages are non-time-triggered in a known manner. In contrast to FIG. 8 shows FIG. 9 (in analogy to FIG. 6) a scenario, in which all four messages 401, 402, 403, 404 are received by the bridge at about the same time. Such a scenario is conceivable since the messages are non-time-triggered. As shown, the maximum latency in this case—in the shown sample for message 404—three message lengths; the maximum latency is therefore higher than shown in FIG. 8.

FIG. 10 shows a sample of the breakdown of the 125 μs intervals into sub-intervals for time-triggered and event-triggered communication. In this sample, it is assumed that a total of 75% of the bandwidth of the communication line can be used for AVB communication. This corresponds to a value of 93.25 μs in each 125 μs interval. In each of these 93.25 μs intervals, one interval with a length of x will be used for time-triggered communication while the remaining interval with a length of 93.25—x will be used for event-triggered communication.

Finally, FIG. 11 represents a schematic view of the internal functioning principle of a bridge 201. The bridge 201 receives messages via incoming communication lines 1101 at the incoming ports 1201. The bridge classifies the incoming messages according to priority and assigns them to logic queues 1401, 1402, 1403 of one or multiple ports 1301—shown in this sample are one port 1301 and three such queues 1401, 1402, 1403. At every port, every one of the queues has been allocated a unique priority. FIG. 11 is a sample of an assignment of ascending priorities: Queue 1401 (lowest priority), Queue 1402, Queue 1403 (highest priority). The priorities will factor into the selection of the next message to be transmitted via the port 1301 to the communication link 1501.

1. A Method for the transmission of messages in a computer network, wherein the computer network comprises a number of computing nodes interconnected via one or multiple active components, wherein each of the number of computing nodes is connected via a communication line to an active component, wherein the number of computing nodes exchange at least a part of the messages in the form of real-time-messages,
wherein defined CM time intervals (CMI) of a constant time duration are allocated to the real-time messages, and wherein
the bandwidth available for real-time messages within a CM time interval is limited to a defined real-time bandwidth,
the method comprising:
periodically transmitting time-triggered messages from the number computing nodes according to a predefined schedule
wherein the period duration of the time-triggered messages is a function of the duration of the CM intervals,
wherein the transmission of time-triggered messages from different ones of the number of computing nodes to a same active component are time-wise out of phase with each other, such that the time-triggered messages from different ones of the number of computing nodes are received in non-overlapping time intervals in the active component,
wherein the total number of the bandwidths occupied by time-triggered messages and real-time messages within one CM time interval does not exceed the value of the real-time bandwidth.

2. A Method according to claim 1 wherein the time-triggered messages are transmitted from at least two of the computing nodes.

3. A Method according to claim 1 the period duration of the time-triggered messages is an integral multiple of a CM time interval.

4. A Method according to claim 1 wherein the period duration of the time-triggered messages is equal to the duration of one CM time interval divided by an integer number.

5. A Method according to claim 1 further comprising transmitting all time-triggered messages during the same period duration.

6. A Method according to claim 1 wherein the transmitting of time-triggered messages from at least two of the number of computing nodes with different period durations.

7. A Method according to claim 1 wherein transmission times of time-triggered messages with the same period duration are selected such that the transmission times of two consecutive time-triggered messages from different computing nodes are separated by exactly or at least one time frame which is equal to the period duration divided by the number of the computing nodes.

8. A Method according to claim 1 further comprising scheduling the transmission of two or more time-triggered messages of different computer nodes within one CM time interval such that the transmission time of the nth time-triggered message occurs at the earliest after expiration of the transmission time of the (n−1)th message plus the duration of the transmission of the (n−1)th message where n is an integer greater than or equal to 2.

9. A Method further comprising transmitting two or more messages from each other differing classes of real-time messages within the network, wherein the differing classes differ at a minimum in the CM-time interval allocated to the messages of the respective class.

10. A Method according to claim 9 wherein real-time messages of a specific class, which are transmitted as time-triggered messages, are transmitted with a period duration which is a function of the CM time interval of these real-time messages.

11. A Method according to claim 9 wherein at least some of the real-time messages are transmitted as time-triggered messages.

12. A Method according to claim 9 wherein at least some of the real-time messages of a specific class are transmitted as time-triggered messages.

13. A Method according to wherein time-triggered messages are transmitted at the beginning of a CM time interval.

14. A Method according to further comprising arbitrarily allocating the bandwidth available for real-time messages to time-triggered and non-time-triggered real-time messages.

15. A Method according to the time-triggered messages have at least the priority of the real-time messages or a higher priority.

16. A Method according to claim 1 wherein time-triggered messages transmitted by the same computing node carry the same identification features.

17. A Method according to claim 1 wherein the length of a CM time interval is in a range between 125 microseconds and 250 microseconds.

18. A method according to claim 1 wherein the defined real-time bandwidth is limited to a maximum of 75% of the bandwidth available for real-time messages within one CM time interval.

19. A Computer network for the execution for the transmission of messages including a number of computing nodes interconnected via one or multiple active components, wherein each of the number of computing nodes is connected to an active component via a communication line, wherein the number of computing nodes are exchanging at least some of the messages in the form of real-time messages, wherein defined Class Measurement Time Intervals of a constant time duration are allocated to the real-time messages, and wherein the bandwidth available for the real-time messages within one CM time interval is limited to a predefined real-time bandwidth,
the network comprising:
at least two computing nodes configured to periodically transmit time-triggered messages
according to a defined schedule,
wherein the period duration of the time-triggered messages is a function of the time duration of the CM intervals,
wherein the transmission times of time-triggered messages being transmitted by different computing nodes to the same active components are phase-shifted in relation each other, such that the time-triggered messages are received by the active component from different computing nodes at
different times in non-overlapping time intervals,
and wherein the total number of the bandwidths occupied by time-triggered messages and real-time messages within one CM time interval does not exceed the value of the real-time bandwidth.
